(19) United States
(12) Patent Application Publication
(10) Pub. No.: US 2021/0281971 A1
(43) Pub. Date: Sep. 9, 2021

(54) TRANSMITTER, RECEIVER, AND DATA DISTRIBUTION SYSTEM

(71) Applicant: TOYOTA JIDOSHA KABUSHIKI KAISHA, Toyota-shi (JP)

(72) Inventors: Mutsumi ABE, Tokyo (JP); Masaki MIYAGAWA, Tokyo (JP); Kota OKAMOTO, Tokyo (JP); Satoshi KATO, Toyota-shi (JP); Takaaki HAGA, Tokyo (JP); Yusuke HARA, Tokyo (JP)

(73) Assignee: TOYOTA JIDOSHA KABUSHIKI KAISHA, Toyota-shi (JP)

(21) Appl. No.: 17/186,864

(22) Filed: Feb. 26, 2021

(30) Foreign Application Priority Data
Mar. 3, 2020 (JP) 2020-036252

(51) Int. Cl. H04W 4/02; G06Q 30/02; H04W 4/90

(52) U.S. Cl. CPC H04W 4/023; G06Q 30/0261; H04W 4/90; G06Q 30/0207

(57) ABSTRACT

A transmitter includes a processor configured to: acquire positional information indicating a position of the transmitter; and transmit, to a receiver, first transmission target data out of transmission target data retained by the transmitter and including a data body and effective range information indicating an effective range of the data body, the first transmission target data including the effective range information indicating a first effective range that covers the position of the transmitter that is indicated by the positional information.

### CROSS-REFERENCE TO RELATED APPLICATION

This application claims priority to Japanese Patent Application No. 2020-036252 filed on Mar. 3, 2020, incorporated herein by reference in its entirety.

### BACKGROUND

### 1. Technical Field

The present disclosure relates to a transmitter, a receiver, and a data distribution system.

### 2. Description of Related Art

Japanese Unexamined Patent Application Publication No. 2017-191968 (JP 2017-191968 A) discloses an on-board device including a wireless communication unit and serving as a component of a network built by multi-hop communication. The on-board device transmits generated information to an external device when the number of hops does not reach a maximum number of hops preset in the generated information. The generated information is generated by an on-board device of a transmission source. The number of hops is the number of other on-board devices that have relayed the generated information.

### SUMMARY

In the technology described in JP 2017-191968 A in which the number of hops is used for determining whether to transmit transmission target data to an external device, information effective in a specific area cannot be distributed.

The present disclosure achieves distribution of information effective in a specific area.

A transmitter according to a first aspect of the present disclosure includes a processor configured to: acquire positional information indicating a position of the transmitter; and transmit, to a receiver, first transmission target data out of transmission target data retained by the transmitter and including a data body and effective range information indicating an effective range of the data body, the first transmission target data including the effective range information indicating a first effective range that covers the position of the transmitter that is indicated by the positional information.

According to the aspect described above, the first transmission target data out of the transmission target data retained by the transmitter is transmitted to the receiver. The first transmission target data includes the effective range information indicating the effective range that covers the position of the transmitter. Thus, information effective in a specific area can be distributed.

In the aspect described above, the processor may be configured to discard second transmission target data including the effective range information indicating a second effective range that does not cover the position of the transmitter that is indicated by the positional information.

According to the configuration described above, the second transmission target data including the effective range information indicating the effective range that does not cover the position of the transmitter is discarded. Thus, information effective in a specific area can be distributed.

In the aspect described above, the data body may include at least one of data indicating a discount coupon available in a shop located in the effective range indicated by the effective range information, advertisement information of the shop, or disaster information related to a disaster in the effective range.

With the configuration described above, information effective in a specific area can be distributed.

In the configuration described above, the processor may be configured to transmit, when communication is established with the receiver, the first transmission target data to the receiver.

A receiver according to a second aspect of the present disclosure includes a processor configured to: receive transmission target data transmitted by a transmitter and including a data body and effective range information indicating an effective range of the data body; acquire positional information indicating a position of the receiver; and control a storage device to store third transmission target data out of the transmission target data received by the processor, the third transmission target data including the effective range information indicating a third effective range that covers the position of the receiver that is indicated by the positional information.

According to the aspect described above, the third transmission target data out of the received transmission target data is stored in the storage device. The third transmission target data includes the effective range information indicating the effective range that covers the position of the receiver. Thus, information effective in a specific area can be distributed.

In the aspect described above, the processor may be configured to discard fourth transmission target data out of the transmission target data received by the processor, the fourth transmission target data including the effective range information indicating a fourth effective range that does not cover the position of the receiver that is indicated by the positional information.

According to the configuration described above, the fourth transmission target data including the effective range information indicating the effective range that does not cover the position of the receiver is discarded. Thus, information effective in a specific area can be distributed.

In the aspect described above, the data body may include at least one of data indicating a discount coupon available in a shop located in the effective range, advertisement information of the shop, and disaster information related to a disaster in the effective range.

With the configuration described above, information effective in a specific area is stored. Thus, information effective in a specific area can be distributed.

A data distribution system according to a third aspect of the present disclosure includes the transmitter according to the first aspect, and the receiver according to the second aspect. In the data distribution system according to the third aspect, information effective in a specific area can be distributed.

The present disclosure attains an effect that information effective in a specific area can be distributed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of the configuration of a data distribution system;

FIG. 2 is a block diagram illustrating an example of the hardware configuration of a terminal device;

FIG. 3 is a diagram illustrating an example of transmission target data;

FIG. 4 is a block diagram illustrating an example of the functional configuration of a terminal device that functions as a transmitter;

FIG. 5 is a block diagram illustrating an example of the functional configuration of a terminal device that functions as a receiver;

FIG. 6 is a flowchart illustrating an example of a data transmitting process;

FIG. 7 is a flowchart illustrating an example of a data receiving process;

FIG. 8 is a diagram for describing a specific example of the data transmitting process and the data receiving process;

FIG. 9 is a diagram for describing a specific example of the data transmitting process and the data receiving process; and

FIG. 10 is a diagram for describing a specific example of the data transmitting process and the data receiving process.

### DETAILED DESCRIPTION OF EMBODIMENTS

An exemplary embodiment of the present disclosure is described below in detail with reference to the drawings.

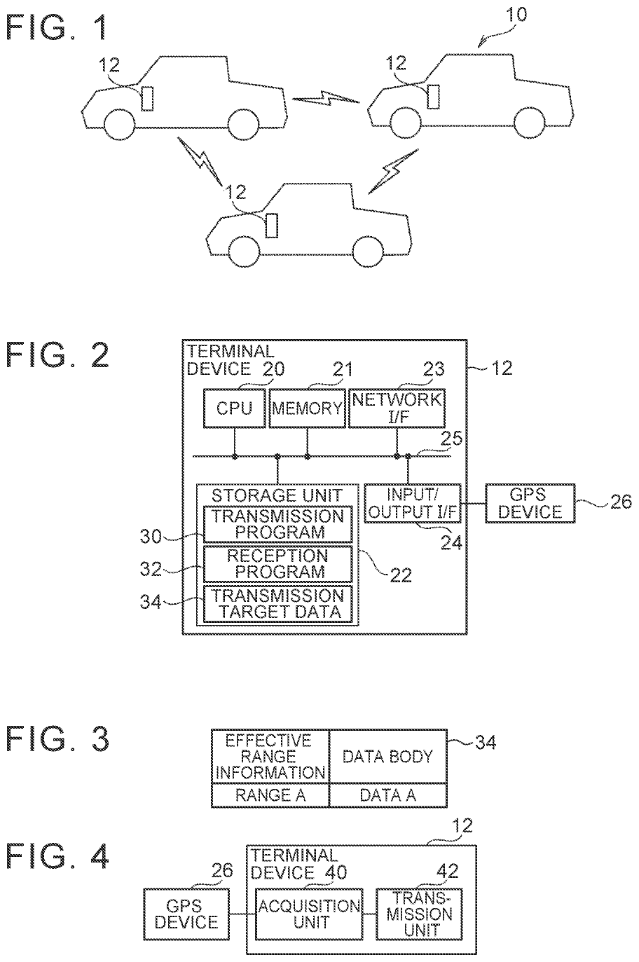

First, the configuration of a data distribution system 10 according to this embodiment is described with reference to FIG. 1. As illustrated in FIG. 1, the data distribution system 10 includes a plurality of terminal devices 12. Each terminal device 12 is provided in a vehicle. Examples of the terminal device 12 include an information terminal configured to transmit and receive data.

Next, the hardware configuration of the terminal device 12 according to this embodiment is described with reference to FIG. 2. As illustrated in FIG. 2, the terminal device 12 includes a central processing unit (CPU) 20, a memory 21 serving as a temporary storage area, and a non-volatile storage unit 22. The terminal device 12 further includes a network interface (I/F) 23 and an input/output I/F 24. The network I/F 23 controls wireless communication. A global positioning system (GPS) device 26 is connected to the input/output I/F 24. The CPU 20, the memory 21, the storage unit 22, the network I/F 23, and the input/output I/F 24 are connected together via a bus 25.

The storage unit 22 is implemented by, for example, a hard disk drive (HDD), a solid state drive (SSD), or a flash memory. The storage unit 22 serving as a storage medium stores a transmission program 30 and a reception program 32. The CPU 20 reads the transmission program 30 from the storage unit 22, loads the transmission program 30 on the memory 21, and executes the loaded transmission program 30. The CPU 20 reads the reception program 32 from the storage unit 22, loads the reception program 32 on the memory 21, and executes the loaded reception program 32. The storage unit 22 also stores transmission target data 34.

The network I/F 23 performs ad hoc communication with other terminal devices 12 in accordance with a predetermined wireless communication scheme such as Institute of Electrical and Electronics Engineers (IEEE) 802.11ac. The ad hoc communication herein refers to direct communication between terminal devices 12 without intervention of a base station or a server device. That is, the terminal device 12 according to this embodiment can transmit and receive data by establishing communication when a distance from another terminal device 12 falls within a range in which wireless communication can be performed in accordance with the communication scheme.

The GPS device 26 measures a position of the terminal device 12 by receiving GPS signals from a plurality of GPS satellites, and outputs, to the CPU 20, positional information indicating the measured position of the terminal device 12. This embodiment is directed to an example in which a latitude and a longitude are applied as the positional information.

Next, the transmission target data 34 is described with reference to FIG. 3. Examples of the transmission target data 34 include data received from another terminal device 12, and data received from an external server device (not illustrated). The transmission target data 34 is data to be transmitted to another terminal device 12.

As illustrated in FIG. 3, the transmission target data 34 includes a data body and effective range information indicating an effective range of the data body. The effective range information according to this embodiment indicates a geographical range. Examples of the effective range information include a combination of a lower limit value and an upper limit value of latitudes and a lower limit value and an upper limit value of longitudes in the geographical range. The data body is data useful in the effective range indicated by the effective range information. Examples of the data body include data indicating a discount coupon available in a shop located in the effective range indicated by the effective range information. Examples of the data body also include advertisement information of the shop located in the effective range indicated by the effective range information, and disaster information related to a disaster in the effective range.

Next, the functional configuration of the terminal device 12 according to this embodiment when the terminal device 12 functions as a transmitter configured to transmit data is described with reference to FIG. 4. As illustrated in FIG. 4, the terminal device 12 includes an acquisition unit 40 and a transmission unit 42. The CPU 20 of the terminal device 12 executes the transmission program 30 stored in the storage unit 22 to function as the acquisition unit 40 and the transmission unit 42 illustrated in FIG. 4.

The acquisition unit 40 acquires, via the input/output I/F 24, positional information indicating a position of the terminal device 12 that is measured by the GPS device 26.

When communication is established with another terminal device 12 that functions as a receiver, the transmission unit 42 transmits, to the other terminal device 12 via the network I/F 23, first transmission target data 34 out of transmission target data 34 retained by the terminal device 12 including the transmission unit 42. The first transmission target data 34 includes effective range information indicating an effective range that covers the position of the terminal device 12 that is indicated by the positional information acquired by the acquisition unit 40. The transmission target data 34 retained by the terminal device 12 herein refers to the transmission target data 34 stored in the storage unit 22.

When communication is established with the other terminal device 12 that functions as the receiver, the transmission unit 42 discards second transmission target data 34 out of the transmission target data 34 retained by the terminal device 12 including the transmission unit 42. The second transmission target data 34 includes effective range information indicating an effective range that does not cover the position of the terminal device 12 that is indicated by the positional information acquired by the acquisition unit 40. The term “discard” herein means deletion from the storage unit 22.

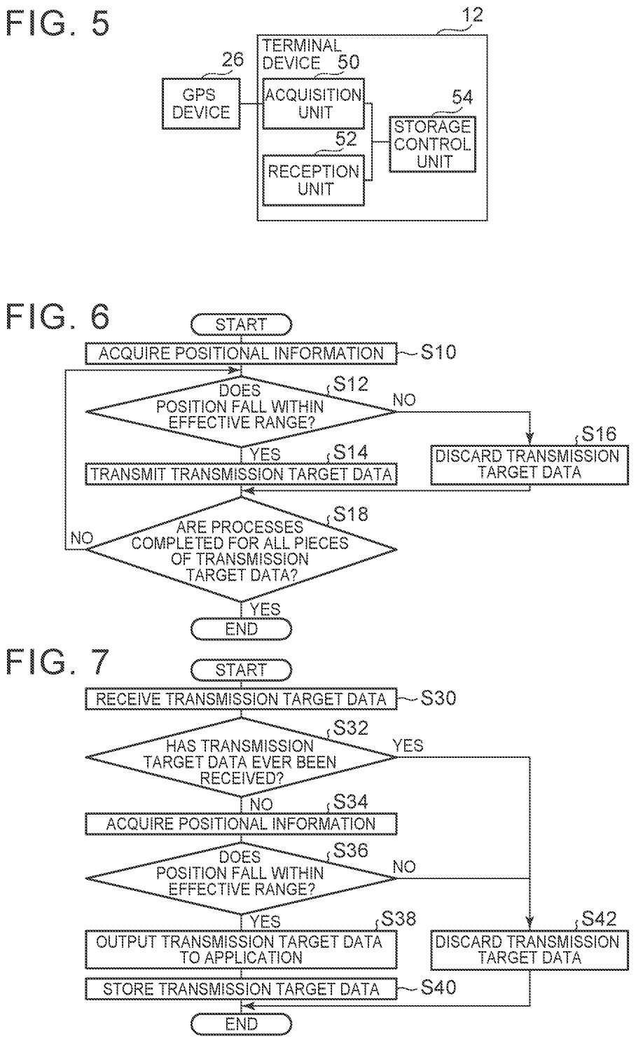

Next, the functional configuration of the terminal device 12 according to this embodiment when the terminal device 12 functions as a receiver configured to receive data is described with reference to FIG. 5. As illustrated in FIG. 5, the terminal device 12 includes an acquisition unit 50, a reception unit 52, and a storage control unit 54. The CPU 20 of the terminal device 12 executes the reception program 32 stored in the storage unit 22 to function as the acquisition unit 50, the reception unit 52, and the storage control unit 54 illustrated in FIG. 5.

The acquisition unit 50 acquires, via the input/output I/F 24, positional information indicating a position of the terminal device 12 that is measured by the GPS device 26. The reception unit 52 receives, via the network I/F 23, transmission target data 34 transmitted by another terminal device 12 that functions as a transmitter.

The storage control unit 54 controls the storage unit 22 being an example of a storage device to store third transmission target data 34 out of the transmission target data 34 received by the reception unit 52. The third transmission target data 34 includes effective range information indicating an effective range that covers the position of the terminal device 12 that is indicated by the positional information acquired by the acquisition unit 50. The storage control unit 54 discards fourth transmission target data out of the transmission target data 34 received by the reception unit 52. The fourth transmission target data includes effective range information indicating an effective range that does not cover the position of the terminal device 12 that is indicated by the positional information acquired by the acquisition unit 50.

Next, actions of the terminal device 12 according to this embodiment are described with reference to FIG. 6 and FIG. 7. The CPU 20 of the terminal device 12 executes a data transmitting process illustrated in FIG. 6 by executing the transmission program 30. For example, the data transmitting process is executed when the terminal device 12 establishes communication with another terminal device 12. The CPU 20 of the terminal device 12 executes a data receiving process illustrated in FIG. 7 by executing the reception program 32. For example, the data receiving process is executed every time the terminal device 12 establishes communication with another terminal device 12 and receives transmission target data 34 transmitted by the other terminal device 12. That is, when the terminal device 12 receives a plurality of transmission target data 34, the data receiving process illustrated in FIG. 7 is executed for each of the received transmission target data 34.

In Step S10 of FIG. 6, the acquisition unit 40 acquires, via the input/output I/F 24, positional information indicating a position of the terminal device 12 that is measured by the GPS device 26. The following processes of Step S12 to Step S16 are executed for all of the transmission target data 34 stored in the storage unit 22 as processing targets. When the processes of Step S12 to Step S16 are repeated, transmission target data 34 that has not been selected as a processing target is the processing target.

In Step S12, the transmission unit 42 determines whether the position of the terminal device 12 that is indicated by the positional information acquired in Step S10 falls within an effective range indicated by effective range information of transmission target data 34 being a processing target. When the result of the determination is negative, the process proceeds to Step S16. When the result of the determination is positive, the process proceeds to Step S14.

In Step S14, the transmission unit 42 transmits the transmission target data 34 being the processing target via the network I/F 23 to the other terminal device 12 that establishes communication. In Step S16, the transmission unit 42 discards the transmission target data 34 being the processing target.

In Step S18, the transmission unit 42 determines whether the processes of Step S12 to Step S16 are completed for all of the transmission target data 34 stored in the storage unit 22. When the result of the determination is negative, the process returns to Step S12. When the result of the determination is positive, the data transmitting process is terminated.

In Step S30 of FIG. 7, the reception unit 52 receives, via the network I/F 23, the transmission target data 34 transmitted through the data transmitting process from the other terminal device 12 that establishes communication. In Step S32, the reception unit 52 determines whether the transmission target data 34 received in Step S30 has already been received. Specifically, the reception unit 52 determines whether the transmission target data 34 received in Step S30 has already been received by determining whether the transmission target data 34 is stored in the storage unit 22. When the result of the determination is positive, the process proceeds to Step S42. When the result of the determination is negative, the process proceeds to Step S34.

In Step S34, the acquisition unit 50 acquires, via the input/output I/F 24, positional information indicating a position of the terminal device 12 that is measured by the GPS device 26. In Step S36, the storage control unit 54 determines whether the position of the terminal device 12 that is indicated by the positional information acquired in Step S34 falls within the effective range indicated by the effective range information of the transmission target data 34 received in Step S30. When the result of the determination is negative, the process proceeds to Step S42. When the result of the determination is positive, the process proceeds to Step S38.

In Step S38, the storage control unit 54 outputs a data body of the transmission target data 34 received in Step S30 to an application program for processing the data body. The application program performs a predetermined process for the data body of the transmission target data 34 received in Step S30. In Step S40, the storage control unit 54 controls the storage unit 22 to store the transmission target data 34 received in Step S30. When the process of Step S40 is completed, the data receiving process is terminated.

In Step S42, the storage control unit 54 discards the transmission target data 34 received in Step S30. When the process of Step S42 is completed, the data receiving process is terminated.

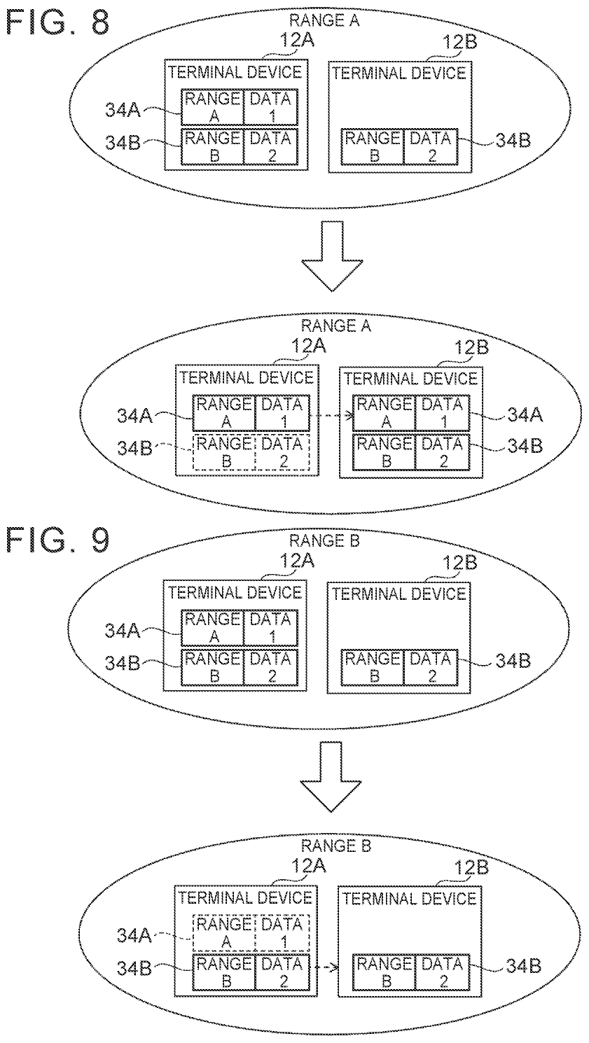

Next, specific examples of the data transmitting process and the data receiving process are described with reference to FIG. 8 to FIG. 10. A terminal device 12 that functions as the transmitter is hereinafter referred to as “terminal device 12A”. A terminal device 12 that functions as the receiver is hereinafter referred to as “terminal device 12B”. Transmission target data 34 including effective range information indicating a “range A” and a data body being “data 1” is hereinafter referred to as “transmission target data 34A”. Transmission target data 34 including effective range information indicating a “range B” and a data body being “data 2” is hereinafter referred to as “transmission target data 34B”.

Referring to FIG. 8, description is given of an example in which the terminal device 12A and the terminal device 12B that are located in the range A establish communication, the storage unit 22 of the terminal device 12A stores the transmission target data 34A and 34B, and the storage unit 22 of the terminal device 12B stores the transmission target data 34B.

In this example, a position indicated by positional information of the terminal device 12A falls within the range A, effective range information of the transmission target data 34A indicates the range A, and effective range information of the transmission target data 34B indicates the range B different from the range A. Thus, the result of the determination in Step S12 is positive for the transmission target data 34A, and the transmission target data 34A is transmitted from the terminal device 12A to the terminal device 12B in Step S14. The result of the determination in Step S12 is negative for the transmission target data 34B, and the transmission target data 34B is deleted from the storage unit 22 of the terminal device 12A in Step S16.

In this example, the terminal device 12B executes the data receiving process for the transmission target data 34A transmitted from the terminal device 12A. In this case, the transmission target data 34A is not stored in the storage unit 22 of the terminal device 12B, and a position indicated by positional information of the terminal device 12B falls within the range A. That is, the result of the determination in Step S32 is negative, and the result of the determination in Step S36 is positive. Therefore, Step S38 and Step S40 are executed. Thus, the transmission target data 34A is stored in the storage unit 22 of the terminal device 12B.

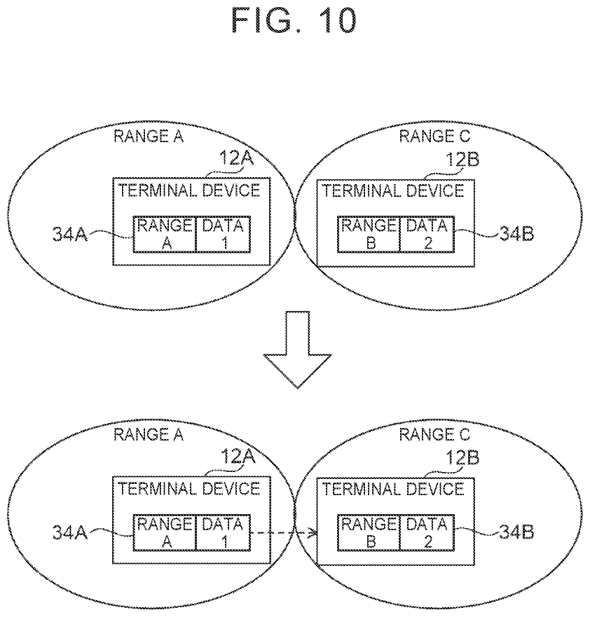

Referring to FIG. 9, description is given of an example in which the terminal device 12A and the terminal device 12B that are located in the range B establish communication, the storage unit 22 of the terminal device 12A stores the transmission target data 34A and 34B, and the storage unit 22 of the terminal device 12B stores the transmission target data 34B.

In this example, the position indicated by the positional information of the terminal device 12A falls within the range B, the effective range information of the transmission target data 34B indicates the range B, and the effective range information of the transmission target data 34A indicates the range A different from the range B. Thus, the result of the determination in Step S12 is positive for the transmission target data 34B, and the transmission target data 34B is transmitted from the terminal device 12A to the terminal device 12B in Step S14. The result of the determination in Step S12 is negative for the transmission target data 34A, and the transmission target data 34A is deleted from the storage unit 22 of the terminal device 12A in Step S16.

In this example, the terminal device 12B executes the data receiving process for the transmission target data 34B transmitted from the terminal device 12A. In this case, the transmission target data 34B is stored in the storage unit 22 of the terminal device 12B, and the result of the determination in Step S32 is positive. Therefore, Step S42 is executed. Thus, the transmission target data 34B received by the terminal device 12B is discarded.

Referring to FIG. 10, description is given of an example in which the terminal device 12A located in the range A and the terminal device 12B located in a range C establish communication, the storage unit 22 of the terminal device 12A stores the transmission target data 34A, and the storage unit 22 of the terminal device 12B stores the transmission target data 34B.

In this example, the position indicated by the positional information of the terminal device 12A falls within the range A, and the effective range information of the transmission target data 34A indicates the range A. Thus, the result of the determination in Step S12 is positive, and the transmission target data 34A is transmitted from the terminal device 12A to the terminal device 12B in Step S14.

In this example, the terminal device 12B executes the data receiving process for the transmission target data 34A transmitted from the terminal device 12A. In this case, the transmission target data 34A is not stored in the storage unit 22 of the terminal device 12B, and the position indicated by the positional information of the terminal device 12B falls within the range C. That is, the result of the determination in Step S32 is negative, and the result of the determination in Step S36 is negative. Therefore, Step S42 is executed. Thus, the transmission target data 34A received by the terminal device 12B is discarded.

As described above, according to this embodiment, transmission target data including effective range information indicating an effective range that covers the position of the transmitter out of the transmission target data retained by the transmitter is transmitted to the receiver. Thus, information effective in a specific area can be distributed. In a method in which transmission target data is stored in a server device and terminal devices acquire the transmission target data from the server device, some terminal devices may fail to acquire the transmission target data from the server device due to access concentration. In this embodiment, the transmission target data is distributed through the ad hoc communication among the terminal devices. Thus, it is possible to reduce the number of terminal devices that may fail to acquire the transmission target data. As a result, it is possible to distribute the transmission target data to more terminal devices.

The embodiment described above is directed to the case where the terminal device 12 is provided in the vehicle, but the present disclosure is not limited to this case. For example, the terminal device 12 may be provided in a moving object other than the vehicle. For example, the terminal device 12 that functions as the transmitter or the terminal device 12 that functions as the receiver may be fixed at a predetermined position in a specific shop.

The processes to be performed by the CPU 20 of the embodiment are described as software processes to be performed by executing the programs, but may be processes to be performed by hardware such as an application specific integrated circuit (ASIC) or a field-programmable gate array (FPGA). Alternatively, the processes to be performed by the CPU 20 may be performed by software and hardware in combination. The transmission program 30 and the reception program 32 to be stored in the storage unit 22 may be distributed by being stored in various storage media.

The present disclosure is not limited to the exemplary embodiment described above, but various modifications other than the exemplary embodiment may be made without departing from the spirit of the present disclosure.

What is claimed is:

1. A transmitter comprising a processor configured to:
acquire positional information indicating a position of the transmitter; and
transmit, to a receiver, first transmission target data out of transmission target data retained by the transmitter and including a data body and effective range information indicating an effective range of the data body, the first transmission target data including the effective range information indicating a first effective range that covers the position of the transmitter that is indicated by the positional information.

2. The transmitter according to claim 1, wherein the processor is configured to discard second transmission target data including the effective range information indicating a second effective range that does not cover the position of the transmitter that is indicated by the positional information.

3. The transmitter according to claim 1, wherein the data body includes at least one of data indicating a discount coupon available in a shop located in the effective range indicated by the effective range information, advertisement information of the shop, or disaster information related to a disaster in the effective range.

4. The transmitter according to claim 1, wherein the processor is configured to transmit, when communication is established with the receiver, the first transmission target data to the receiver.

5. A receiver comprising a processor configured to:
receive transmission target data transmitted by a transmitter and including a data body and effective range information indicating an effective range of the data body;
acquire positional information indicating a position of the receiver; and
control a storage device to store third transmission target data out of the transmission target data received by the processor, the third transmission target data including the effective range information indicating a third effective range that covers the position of the receiver that is indicated by the positional information.

6. The receiver according to claim 5, wherein the processor is configured to discard fourth transmission target data out of the transmission target data received by the processor, the fourth transmission target data including the effective range information indicating a fourth effective range that does not cover the position of the receiver that is indicated by the positional information.

7. The receiver according to claim 5, wherein the data body includes at least one of data indicating a discount coupon available in a shop located in the effective range, advertisement information of the shop, or disaster information related to a disaster in the effective range.

8. A data distribution system comprising:
a transmitter including a first processor configured to
acquire positional information indicating a position of the transmitter, and
transmit, to a receiver, first transmission target data out of transmission target data retained by the transmitter and including a data body and effective range information indicating an effective range of the data body, the first transmission target data including the effective range information indicating a first effective range that covers the position of the transmitter; and
the receiver including a second processor configured to
receive the transmission target data transmitted by the transmitter,
acquire positional information indicating a position of the receiver, and
control a storage device to store third transmission target data out of the transmission target data received by the second processor, the third transmission target data including the effective range information indicating a third effective range that covers the position of the receiver.
